(19) United States
(12) Patent Application Publication
(10) Pub. No.: US 2009/0312089 A1
(43) Pub. Date: Dec. 17, 2009

(54) SLOT MACHINE AND PLAYING METHOD THEREOF

(75) Inventor: Nakayasu TSUKAHARA, Koto-Ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aruze Corp., Koto-Ku (JP)

(21) Appl. No.: 12/480,272

(22) Filed: Jun. 8, 2009

Related U.S. Application Data
(60) Provisional application No. 61/061,501, filed on Jun. 13, 2008.

(51) Int. Cl. A63F 9/24; A63F 13/00

(52) U.S. Cl. 463/20; 463/25; 463/30

(57) ABSTRACT

A slot machine according to the present invention stores in a memory, BET information including the number of BETs placed in a previous game. In a next game, the slot machine accepts input operation made to an input device and in accordance with the input operation from the input device, accepts a first instruction signal and a second instruction signal output from a predetermined electric circuit. The slot machine automatically sets the number of BETs equal to that of BETs placed in the previous game while automatically rearranging the plural types of symbols on a display device, based upon the accepted first and second instruction signals and the BET information concerning the previous game stored in the memory. The input device is configured so as to reciprocate in accordance with the input operation. The predetermined electric circuit is under opening and closing control in accordance with reciprocation of the input device. The slot machine is configured so as to output the first and second instruction signals in this manner.

### CROSS-REFERENCE TO RELATED APPLICATIONS

This application claims priority of U.S. Provisional Application No. 61/061,501 filed on Jun. 13, 2008. The contents of this application are incorporated herein by reference in their entirety.

### BACKGROUND OF THE INVENTION

1. Field of the Invention

The present invention relates to a slot machine and a playing method thereof, which allow players to enjoy slot games with the use of gaming media such as coins or bills.

2. Description of the Related Art

In a conventional slot machine, the number of BETs placed on a game is set by input operation, whereas a plurality of symbols are displayed in a scrolling manner by input operation made to a SPIN button and are then automatically displayed in a stopped manner on a display device provided at a front face of a casing. As described above, a game is started in the slot machine by a player's operating the SPIN button after operating a BET button. An example of conventional slot machines is disclosed in US Published Patent Application No. 20070123332 A1, in which a player performs operation twice, i.e., operation to a BET button and operation to a SPIN button.

Further, the conventional slot machine is provided with a CONTINUOUS PLAY switch, control of which renders the slot machine in a continuous play mode. In the continuous play mode, as long as the credit remains enough to play a game, reels are automatically controlled in a rotational manner in each game to automatically execute another game in a continuous manner. The slot machine as mentioned above is disclosed in U.S. Pat. No. 6,935,949 B1.

The present invention provides a slot machine and a playing method thereof, which can offer entertainability to players that has not been successfully attained by those of the aforementioned conventional art.

### SUMMARY OF THE INVENTION

A first aspect of the present invention is a slot machine including: (i) a display device having thereon plural types of symbols arranged; (ii) a memory for storing BET information including the number of BETs placed in a previous game; (iii) an input device which includes a predetermined electric circuit for outputting a first instruction signal intended to automatically set the number of BETs by referring to the BET information concerning the previous game, stored in the memory, and a second instruction signal intended to automatically rearrange the plural types of symbols on the display device; accepts input operation; and exercises opening and closing control over the predetermined electric circuit so as to output the first instruction signal and the second instruction signal in accordance with the accepted input operation; and (iv) a controller. The controller is programmed to: (a) store in the memory, the BET information including the number of BETs placed in the previous game; (b) accept the input operation made to the input device in a next game; (c) accept the first instruction signal and the second instruction signal output from the predetermined electric circuit in accordance with the input operation made to the input device; (d) automatically set the number of BETs equal to that of BETs placed in the previous game, based upon the first instruction signal accepted in the itemized (c) and the BET information concerning the previous game, stored in the memory in the itemized (a); (e) automatically rearrange the plural types of symbols on the display device based upon the second instruction signal accepted in the itemized (c); and (f) award a prize with a predetermined value in a case where the plurality of symbols rearranged on the display device form a predetermined combination.

According to the first aspect of the present invention, the first and second instruction signals are output in accordance with the input operation made to the input device, so that two instructions can be output from the single input device. The first instruction signal is intended to automatically set the number of BETs by referring to the BET information concerning the previous game stored in the memory. The second instruction signal is intended to automatically rearrange the plural types of symbols on the display device. Therefore, unlike a conventional art, the player is not required to perform operation twice, i.e., operation to a BET button and operation to a SPIN button, thereby facilitating player's input operation. Thus, such a problem can be solved, that operation is burdensome for the player especially when he or she plays a game for a long time. Furthermore, the player always operates to give a game starting instruction for each of games, thereby being able to proceed a game in his or her rhythm. Unlike another conventional art, the player participates in no operation during a continuous play mode, except one made to a CONTINUOUS PLAY switch. Thus, such a problem can be avoided, that the player gets bored with the game. Specifically, the first aspect of the present invention facilitates player's operation while ensuring player's participation in the operation. Furthermore, the number of BETs placed in a next game is set to be equal to that of BETs placed in the last game, so that player's intention can be directly reflected in the next game.

A second aspect of the present invention is a slot machine constituted as set forth below. In the first aspect, the input device is configured so as to reciprocate in accordance with the input operation. The predetermined electric circuit is configured so as to output the first and second instruction signals under opening and closing control in accordance with reciprocation of the input device.

According to the second aspect of the present invention, the slot machine is configured so as to output the first and second instruction signals in accordance with reciprocation of the input device, so that the player can give two instructions by performing a single input operation to the input device.

A third aspect of the present invention is a slot machine constituted as set forth below. In the first aspect, the memory stores an electric gaming value. The controller, in the next game, executes: the itemized (d) and (e) in a case where the electronic gaming value stored in the memory is greater than or equal to the number of BETs placed in the previous game, stored in the memory; and the itemized (d) and (e) after acceptance of a gaming value added by a player, in a case where the electronic gaming value stored in the memory is smaller than the number of BETs placed in the previous game, stored in the memory.

According to the third aspect of the present invention, the number of BETs and the like are set in a case where an electric gaming value stored in the memory is greater than or equal to the number of placed BETs or, even when the gaming value is smaller, another gaming medium is added. Therefore, the number of BETs placed in the previous game can be held to the next game and be set as the number of BETs.

A fourth aspect of the present invention is a slot machine constituted as set forth below. In the first aspect, the BET information stored in the memory includes the number of BETs placed on a predetermined symbol selected in the previous game. The controller: stores in the memory, in the itemized (a), the BET information including the number of BETs placed on the predetermined symbol selected in the previous game; automatically sets, in the itemized (d), the number of BETs placed on the predetermined symbol selected in the previous game, based upon the first instruction signal accepted in the itemized (c) and the BET information concerning the previous game, stored in the memory in the itemized (a); and awards a prize with a predetermined value, in the itemized (f), in a case where the plurality of symbols including the predetermined symbol, rearranged on the display device, form a predetermined combination.

According to the fourth aspect of the present invention, the memory previously stores a predetermined symbol on which the player placed BETs in the previous game and the number of BETs placed on the predetermined symbol. Therefore, the predetermined symbol on which the player placed BETs in the previous game and the number of BETs placed on this predetermined symbol can be directly reflected in the next game, by referring to the memory in the next game. Accordingly, the slot machine facilitates player's operation for selecting a predetermined symbol and for setting the number of BETs, while letting the player concentrate and be amused with the game itself.

A fifth aspect of the present invention is a slot machine constituted as set forth below. In the first aspect, the BET information stored in the memory includes the number of BETs placed on at least one payline set in the previous game. The controller: stores in the memory, in the itemized (a), the BET information including the number of BETs placed on the at least one payline set in the previous game; automatically sets, in the itemized (d), the number of BETs placed on the at least one payline set in the previous game, based upon the first instruction signal accepted in the itemized (c) and the BET information concerning the previous game stored in the memory, in the itemized (a); and awards a prize with a predetermined value, in the itemized (f), in a case where the plurality of symbols rearranged on the display device form a predetermined combination on the at least one set payline.

According to the fifth aspect of the present invention, the memory previously stores a predetermined payline on which the player placed BETs in the previous game and the number of BETs which the player placed on the predetermined payline. Therefore, the predetermined payline on which the player placed BETs in the previous game and the number of BETs placed on this predetermined payline can be directly reflected in the next game, by referring to the memory in the next game. Accordingly, the slot machine facilitates player's operation for selecting a predetermined payline and for setting the number of BETs, while letting the player concentrate and be amused with the game itself.

A sixth aspect of the present invention is a slot machine constituted as set forth below. In the first aspect, the input device is automatically subjected to the input operation upon completion of the previous game.

According to the sixth aspect of the present invention, the input device is automatically operated for each of games, thereby saving player's trouble of performing the input operation to the input device.

A seventh aspect of the present invention is a slot machine constituted as set forth below. In the first aspect, the input device is automatically subjected to the input operation during a predetermined period of a game.

According to the seventh aspect of the present invention, the input device is automatically operated only during a predetermined period of a game, thereby saving player's trouble of performing the input operation to the input device during the predetermined period of a game.

An eighth aspect of the present invention is a slot machine constituted as set forth below. In the first aspect, the slot machine further includes a reset input device for accepting a predetermined input operation. The input device is automatically subjected to the input operation during a period from acceptance of the input operation made to the input device to the predetermined input operation made to the reset input device.

According to the eighth aspect of the present invention, the input device is automatically subjected to the input operation until acceptance of input operation made to the reset input device, thereby saving player's trouble of making the input operation to the input device. At the same time, the reset input device is subjected to the input operation based upon player's intention, thereby controlling the automatic input operation of the input device in accordance with player's intention.

A ninth aspect of the present invention is a slot machine including: (i) a display device having thereon plural types of symbols arranged; (ii) a memory for storing BET information including the number of BETs placed on a predetermined symbol selected in a previous game; (iii) an input device which includes a predetermined electric circuit for outputting a first instruction signal intended to automatically set the number of BETs by referring to the BET information concerning the previous game, stored in the memory, and a second instruction signal intended to automatically rearrange the plural types of symbols on the display device; accepts input operation; and exercises opening and closing control over the predetermined electric circuit so as to output the first instruction signal and the second instruction signal in accordance with the accepted input operation; and (iv) a controller. The controller is programmed to: (a) store in the memory, the BET information including the number of BETs placed on the predetermined symbol selected in the previous game; (b) accept the input operation made to the input device in a next game; (c) accept the first instruction signal and the second instruction signal output from the predetermined electric circuit in accordance with the input operation made to the input device; (d) determine a symbol different from the predetermined symbol selected in the previous game and automatically set to place on the determined different symbol, the number of BETs equal to that of BETs placed in the previous game, based upon the first instruction signal accepted in the itemized (c) and the BET information concerning the previous game, stored in the memory in the itemized (a); (e) automatically rearrange the plural types of symbols on the display device based upon the second instruction signal accepted in the itemized (c); and (f) award a prize with a predetermined value in a case where the plurality of symbols including the different symbol, rearranged on the display device form a predetermined combination.

According to the ninth aspect of the present invention, the memory previously stores a predetermined symbol on which the player placed BETs in the previous game and the number of BETs which the player placed on the predetermined symbol. Therefore, the predetermined symbol on which the player placed BETs in the previous game and the number of BETs placed on this predetermined symbol can be directly reflected in the next game, by referring to the memory in the next game. Furthermore, the first and second instruction signals are output in accordance with the input operation made to the input device, so that two instructions can be output from the single input device. The first instruction signal is intended to automatically set the number of BETs by referring to the BET information concerning the previous game stored in the memory. The second instruction signal is intended to automatically rearrange the plural types of symbols on the display device. Therefore, player's input operation can be facilitated, whereas the player always operates to give a game starting instruction for each of games, so that the player can be amused and play the game in his or her rhythm. One of the two instructions is intended to automatically set the number of BETs in the next game, equal to that of BETs placed in the previous game, so that the player can concentrate on the game without consideration of the number of BETs for each of games. Further, the number of BETs placed in the next game can be set equal to that of BETs placed in the last game, so that player's intention toward the number of BETs in the previous game can be directly reflected in the number of BETs in the next game. Yet further, the symbols can be automatically rearranged with the other instruction, so that player's input operation can be further facilitated.

A tenth aspect of the present invention is a slot machine including: (i) a display device having thereon plural types of symbols arranged; (ii) a memory for storing BET information including the number of BETs placed on at least one payline set in a previous game; (iii) an input device which includes a predetermined electric circuit for outputting a first instruction signal intended to automatically set the number of BETs by referring to the BET information concerning the previous game, stored in the memory, and a second instruction signal intended to automatically rearrange the plural types of symbols on the display device; accepts input operation; and exercises opening and closing control over the predetermined electric circuit so as to output the first instruction signal and the second instruction signal in accordance with the accepted input operation; and (iv) a controller. The controller is programmed to: (a) store in the memory, the BET information including the number of BETs placed on the at least one payline set in the previous game; (b) accept the input operation made to the input device in a next game; (c) accept the first instruction signal and the second instruction signal output from the predetermined electric circuit in accordance with the input operation made to the input device; (d) determine a payline different from the predetermined payline set in the previous game and automatically set to place on the determined different payline, the number of BETs equal to that of BETs placed in the previous game, based upon the first instruction signal accepted in the itemized (c) and the BET information concerning the previous game, stored in the memory in the itemized (a); (e) automatically rearrange the plural types of symbols on the display device based upon the second instruction signal accepted in the itemized (c); and (f) award a prize with a predetermined value in a case where the plurality of symbols rearranged on the display device form a predetermined combination on the at least one set payline.

According to the tenth aspect of the present invention, the memory previously stores a predetermined payline on which the player placed BETs in the previous game and the number of BETs which the player placed on the predetermined payline. Therefore, the predetermined payline on which the player placed BETs in the previous game and the number of BETs placed on this predetermined payline can be directly reflected in the next game, by referring to the memory in the next game. Furthermore, the first and second instruction signals are output in accordance with the input operation made to the input device, so that two instructions can be output from the single input device. The first instruction signal is intended to automatically set the number of BETs by referring to the BET information concerning the previous game stored in the memory. The second instruction signal is intended to automatically rearrange the plural types of symbols on the display device. Therefore, player's input operation can be facilitated, whereas the player always operates to give a game starting instruction for each of games, so that the player can be amused and play the game in his or her rhythm. One of the two instructions is intended to automatically set the number of BETs in the next game, equal to that of BETs placed in the previous game, so that the player can concentrate on the game without consideration of the number of BETs for each of games. Further, the number of BETs placed in the next game can be set equal to that of BETs placed in the last game, so that player's intention toward the number of BETs in the previous game can be directly reflected in the number of BETs in the next game. Yet further, the symbols can be automatically rearranged with the other instruction, so that player's input operation can be further facilitated.

An eleventh aspect of the present invention is a method of playing a slot machine, comprising the steps of: (i) storing in a memory, BET information including the number of BETs in a previous game; (ii) accepting a first instruction signal and a second instruction signal output in accordance with reciprocation of an input device, the first instruction signal being intended to automatically set the number of BETs by referring to the BET information concerning the previous game, stored in the memory, the second instruction signal being intended to automatically rearrange plural types of symbols on a display device; (iii) automatically setting the number of BETs equal to that of BETs in the previous game, based upon the first instruction signal accepted in the itemized (ii) and the BET information concerning the previous game, stored in the memory in the itemized (i); and (iv) automatically rearranging the plural types of symbols on the display device, based upon the second instruction signal accepted in the itemized (ii).

According to the eleventh aspect of the present invention, the first and second instruction signals are output in accordance with the input operation made to the input device, so that two instructions can be output from the single input device. The first instruction signal is intended to automatically set the number of BETs by referring to the BET information concerning the previous game stored in the memory. The second instruction signal is intended to automatically rearrange the plural types of symbols on the display device. Therefore, player's input operation can be facilitated, whereas the player always operates to give a game starting instruction for each of games, so that the player can be amused and play the game in his or her rhythm. One of the two instructions is intended to automatically set the number of BETs in the next game, equal to that of BETs placed in the previous game, so that the player can concentrate on the game without consideration of the number of BETs for each of games. Further, the number of BETs placed in the next game can be set equal to that of BETs placed in the last game, so that player's intention toward the number of BETs in the previous game can be directly reflected in the number of BETs placed in the next game. Yet further, the symbols can be automatically rearranged with the other instruction, so that player's input operation can be further facilitated.

According to the present invention, in accordance with input operation from an input device, BET information concerning a next game can be automatically set by referring to BET information concerning a previous game, whereas a plurality of symbols can be automatically rearranged. Therefore, a slot machine and a playing method thereof, having added new entertainability can be provided.

### BRIEF DESCRIPTION OF THE DRAWINGS

FIG. 1 is a flowchart showing a subroutine of a game execution process;

FIGS. 2A to 2C are views each showing a UTILITY button;

FIG. 3 is a perspective view showing an appearance of a slot machine;

FIG. 4 is a view showing code numbers and symbols displayed in each of display block columns;

FIG. 5 is a view illustrating a prize;

FIG. 6 is a block diagram showing an internal configuration of the slot machine;

FIG. 7 is a flowchart showing a subroutine of a game execution process, which is identical to that of in FIG. 1;

FIG. 8 is a flowchart showing a subroutine of a symbol determination process;

FIG. 9 is a flowchart showing a subroutine of a game execution process according to another embodiment; and

FIG. 10 is a flowchart showing a subroutine of a game execution process according to another embodiment.

### DESCRIPTION OF THE PREFERRED EMBODIMENTS

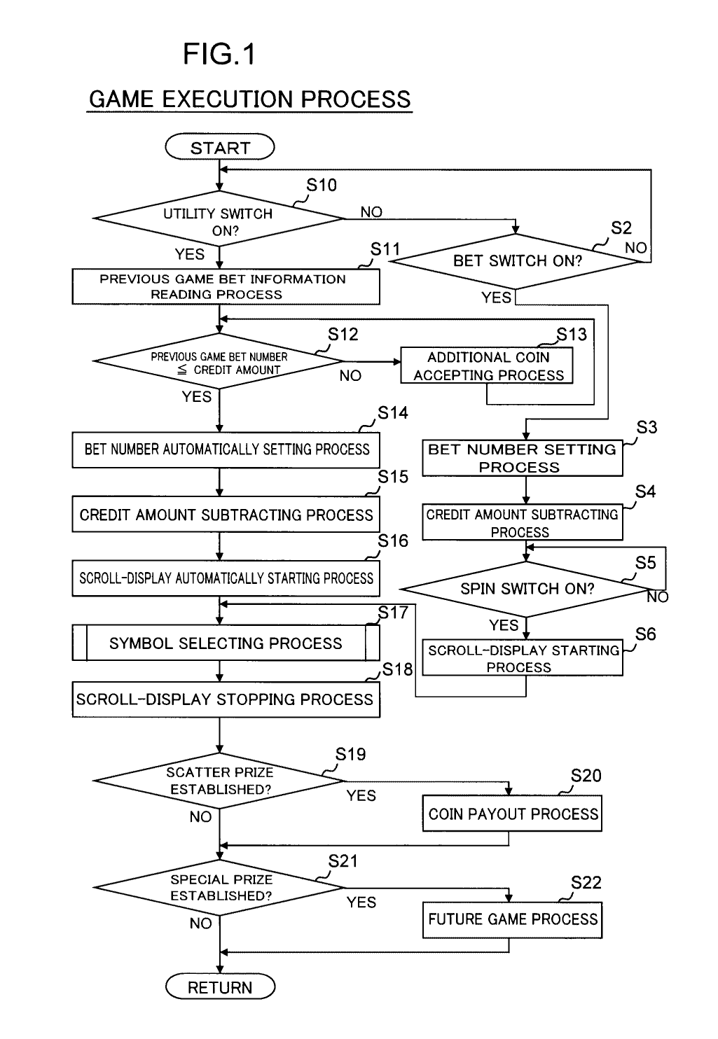

Hereinafter, one embodiment of a slot machine and a playing method thereof, according to the present invention, will be described by referring to the drawings. FIG. 1 is a flowchart showing a subroutine of a game execution process of the slot machine according to a first embodiment.

A main CPU 41 included in the slot machine 10 according to this embodiment stores in the RAM 43, BET information including the number of BETs placed in a previous game. The main CPU 41 judges whether or not a UTILITY switch is set to ON, as shown in FIG. 1 (step S10). Specifically, the main CPU 41 judges whether or not it receives an auto-BET signal A1 (a first instruction signal) output from an auto-BET circuit 210 and an auto-SPIN signal A2 (a second instruction signal) output from an auto-SPIN circuit 220, in response to reciprocation of a UTILITY button 200 caused by player's input operation.

Next, upon judging that the UTILITY switch is set to ON (S10: YES), the main CPU 41 reads out the current credit amount and BET information concerning a previous game stored in a RAM 43 (step S11). The main CPU 41 then judges whether or not the current credit amount read out of the RAM 43 is greater than or equal to the number of BETs placed in the previous game (step S12). On the other hand, upon judging that the UTILITY switch is not set to ON (S10: NO), the main CPU 41 judges whether or not a BET switch is set to ON. When the BET switch is judged as being set to ON, the number of BETs is set in accordance with operation through the BET button, as per normal (step S3), and a scroll-display starting process is executed in accordance with operation made to the SPIN button.

Next, the main CPU 41 executes a BET number automatic setting process upon judging that the current credit amount is greater than or equal to the number of BETs placed in the previous game (S12: YES). Here, the main CPU 41 automatically sets the number of BETs equal to that of BETs placed in the previous game, based upon the auto-BET signal A1 received at step S10 and the number of BETs placed in the previous game included in the BET information, by referring to the BET information concerning the previous game read out of the RAM 43 at step S11 (step S14).

Next, the main CPU 41 automatically executes the scroll-display starting process to the plural types of symbols, based upon the auto-SPIN signal A2 received at step S10 (step S16). When a predetermined time has elapsed after start of the scroll-display, the main CPU 41 displays (rearranges) the plural types of symbols in a stopped manner, following stop of the scroll-display (step S18).

The main CPU 41 then counts the number of symbols of the same type, rearranged in the respective display blocks 28. As a result of counting, in a case where three or more symbols of the same type, which are set as a trigger for a scatter prize, are rearranged in any of the display blocks 28, the main CPU 41 pays out coins in accordance with the number and type of scatter symbols and the number of BETs (S20). The main CPU 41 executes a future game as a special prize in a case where three or more symbols “EARTH”, which are set as a trigger for the special prize, are rearranged (S22).

As described above, the slot machine 10 is configured to allow players to select either one of two ways to execute game, one way being carried out by operation to the UTILITY button 200, the other way being carried out by operation to a normal BET buttons 26, 27 and a SPIN button 23.

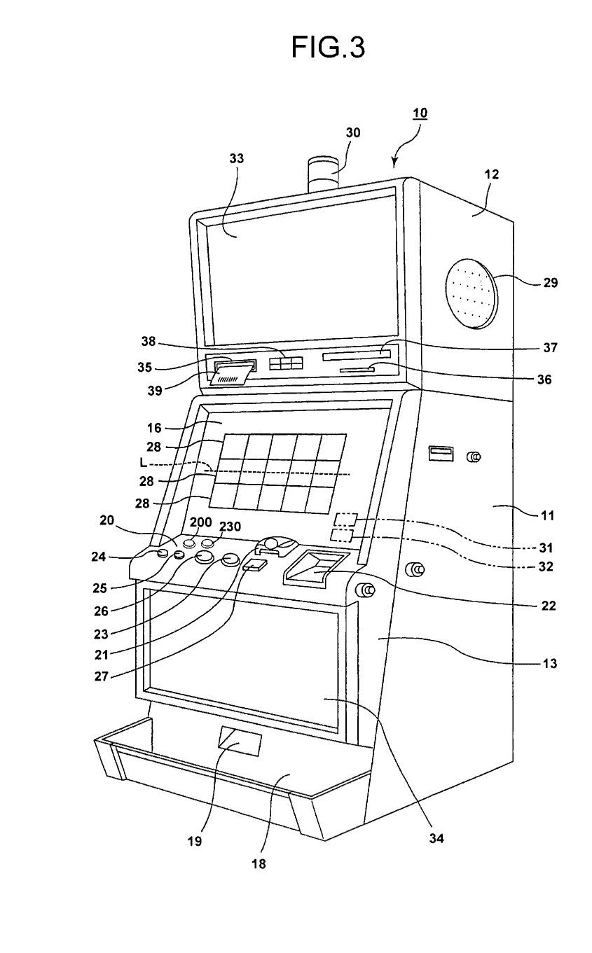

Next, a configuration of the slot machine 10 will be explained with reference to FIG. 3. FIG. 3 is a perspective view showing an appearance of a slot machine 10. The slot machine of the present embodiment is a video type slot machine, whereas the present invention is applicable to a slot machine of a mechanical reel type. Further, the slot machine 10 is a standalone type, which is not connected to a network, whereas the present invention is applicable to a networked slot machine.

The gaming media used in the slot machine 10 include coins, bills, or electronic value information equivalent thereto. In the present invention, however, medals, tokens, electronic money, or tickets, for example, may be employed as gaming mediums without being limitative thereto in particular. As the above-mentioned tickets, for example, bar code-attached tickets, as described later, may be employed without being limitative thereto in particular.

The slot machine 10 is provided with: a cabinet 11; a top box 12 installed at the upper side of the cabinet 11; and a main door 13 provided at the front face of the cabinet 11.

A lower image display panel 16 serving as a display device is provided in front of the main door 13. The lower image display panel 16 is provided with a liquid crystal panel, which displays the cells of the symbol matrix 28 (28a to 28o) in three rows of five columns. A single symbol is displayed in each of the display block 28. The lower image display panel 16 is equivalent to a display device according to the present invention.

A credit amount display section 31 and a payout amount display section 32 are set on the lower image display panel 16. The credit amount display section 31 displays the number of credited coins by way of image. At the payout display portion 32, the number of coins is displayed by way of image, the coins being paid out in a case where symbols of the same type are displayed in a stopped manner by a predetermined number or more in the display blocks 28.

Further, a touch panel 69 is provided, although not shown, on the front face of the lower image display panel 16, so that a player can enter various instructions by operating the touch panel 69.

Provided downwardly of the lower image display panel 16 are: a control panel 20 made of a plurality of buttons 23 to 27 for a player to input instructions associated with the progress of a game; a coin insertion slot 21 for accepting coins in the cabinet 11; and a bill validator 22.

The control panel 20 is provided with a SPIN button 23, a CHANGE button 24, a CASHOUT button 25, a 1-BET button 26, a MAX-BET button 27, the UTILITY button 200, and a RESET button 230. The SPIN button 23 is intended to enter an instruction for starting scroll-display of symbols. The CHANGE button 24 is intended for use in asking an attendant of the gaming facility for change. The CASHOUT button 25 is intended to enter an instruction for paying out credited coins to the coin tray 18. The UTILITY button 200 is equivalent to an input device according to the present invention, whereas the RESET button 230 is equivalent to a reset input device according to the present invention.

The 1-BET button 26 is intended to enter an instruction for betting one of the credited coins on a game. The MAX-BET button 27 is intended to enter an instruction for betting the maximum number of credited coins (50 coins in the embodiment) that can be bet on one game.

The UTILITY button 200 is intended to input the auto-BET signal A1 (the first instruction signal) and the auto-SPIN signal A2 (the second instruction signal). The auto-BET signal A1 is intended to automatically set the number of BETs by referring to the BET information concerning the previous game stored in the RAM 43. The auto-SPIN signal A2 is to automatically rearrange the plural types of symbols in the respective display blocks 28. The auto-BET signal A1 and the auto-SPIN signal A2 are output from the auto-BET circuit 210 and the auto-SPIN circuit 220, respectively, in response to the input operation performed by a player with the UTILITY button 200, as described later. With the slot machine 10 according to the present invention, players can select either one of two ways to execute a game, one way being carried out by operation to the UTILITY button 200, the other way being carried out by operation to normal BET buttons 26, 27 and the SPIN button 23.

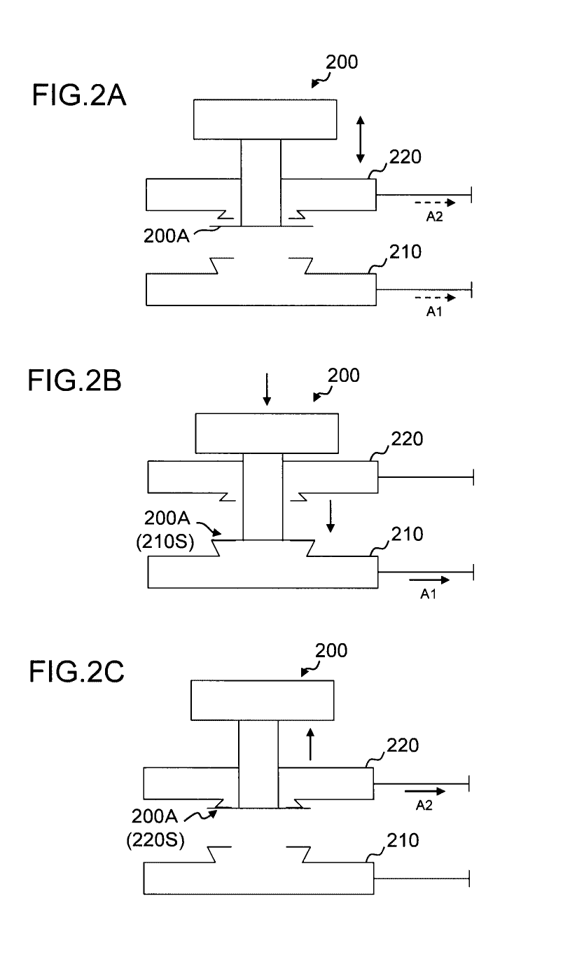

FIGS. 2A to 2C are views each showing the UTILITY button. The UTILITY button 200 includes: a contact piece 200A functioning as a switch formed at a lower end of the UTILITY button 200; the auto-BET circuit 210 for outputting the auto-BET signal A1; and the auto-SPIN circuit 220 for outputting the auto-SPIN signal A2, as shown in FIG. 2A. As shown in FIG. 2A, the UTILITY button 200 is configured so as to reciprocate the contact piece 200A between the auto-BET circuit 210 and the auto-SPIN circuit 220 upon receipt of the input operation by the player. The contact piece 200A functions as an electronic switch for both the auto-BET circuit 210 and the auto-SPIN circuit 220, in response to reciprocation of the UTILITY button 200. Each of the auto-BET circuit 210 and the auto-SPIN circuit 220 is equivalent to a predetermined electric circuit according to the present invention.

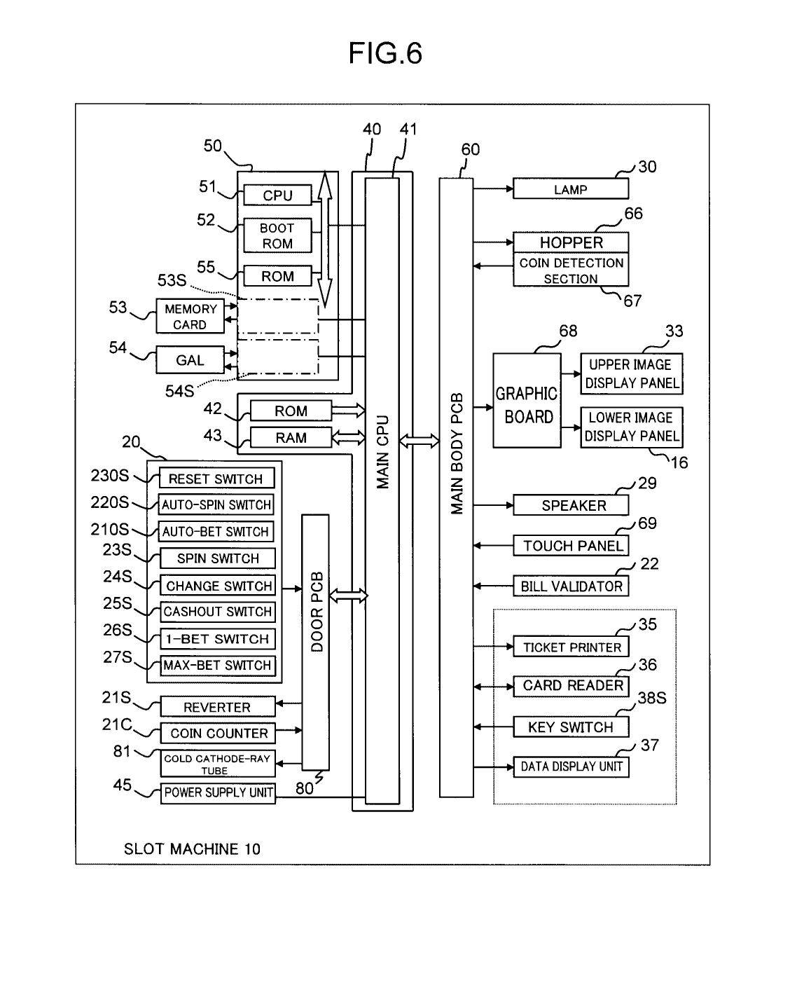

As shown in FIG. 2B, the auto-BET circuit 210 is configured so as to be closed with the contact piece 200A of the UTILITY button 200 at the time of pressing of the UTILITY button 200, because the contact piece 200A functions as an auto-BET switch 210S (see FIG. 6). Specifically, upon pressing of the UTILITY button 200, the auto-BET switch 210S becomes an electrically ON state. Accordingly, where the auto-BET switch 210S becomes the electrically ON state, the auto-BET circuit 210 outputs the auto-BET signal A1 for automatically setting the number of BETs equal to that of BETs placed in the previous game.

As shown in FIG. 2C, the auto-SPIN circuit 220 is configured so as to be closed with the contact piece 200A of the UTILITY button 200 at the time that the UTILITY button 200 is returned to a position above its previous position after pressing thereof, because the piece 200A functions as an auto-SPIN switch 220S (see FIG. 6). Specifically, upon returning of the UTILITY button 200 to its return position, the auto-SPIN switch 220S becomes an electrically ON state. Accordingly, where the auto-SPIN switch 220S becomes the electrically ON state, the auto-SPIN circuit 220 outputs the auto-SPIN signal A2 for automatically rearranging the plural types of symbols in the respective display blocks 28.

The RESET button 230 is intended to enter an instruction for canceling the auto-BET signal A1 output from the auto-BET circuit 210 and the auto-SPIN signal A2 output from the auto-SPIN circuit 220.

The insertion of gaming media denotes that gaming media are bet on games. For example, in a case where the coins inserted into the coin insertion slot 21 are directly bet on games, coin insertion into the coin insertion slot 21 is equivalent to insertion of gaming media. Specifically, if coins are inserted into the coin insertion slot 21, they are temporarily credited. When the 1-BET button 26 and the MAX-BET button 27 are operated, the credited coins are bet on games. In this case, insertion of gaming media indicates that the credited coins are bet on a game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

The front face of the top box 12 is provided with an upper image display panel 33. The upper image display panel 33 has a liquid crystal panel, which displays images for introducing the game contents or explaining game rules, for example. In addition, the upper image display panel 33 displays effect images at the time of establishment of a future game as a special prize.

The top box 12 is provided with a speaker 29. At the lower side of the upper image display panel 33, a ticket printer 35, a card reader 36, a data display 37, and a keypad 38 are provided. The ticket printer 35 prints, on tickets, bar codes containing coded data such as credit amount, date and time, or ID numbers of the slot machine 10, and the bar code-attached tickets 39 are output. A player causes another slot machine to read the bar-code-attached tickets 39, allowing the slot machine to perform games, or alternatively, allowing the exchange of bar-code-attached tickets 39 with bills or the like at a predetermined site of a game facility (for example, at the casher in a casino).

The card reader 36 is intended to read and write data from/into a smart card. The smart card is a player-owned card, and stores data for recognizing a player and data concerning the log of games that were performed by the player. The smart card may store data equivalent to coins, bills, or credits. In place of the smart card, further, a magnetic stripe card may be employed. A data display 37 is made up of a fluorescent display or the like, and displays the data read by the card reader 36 and the data input by the player via the keypad 38, for example. The keypad 38 is intended to enter the instructions or data pertinent to the issuance of tickets.

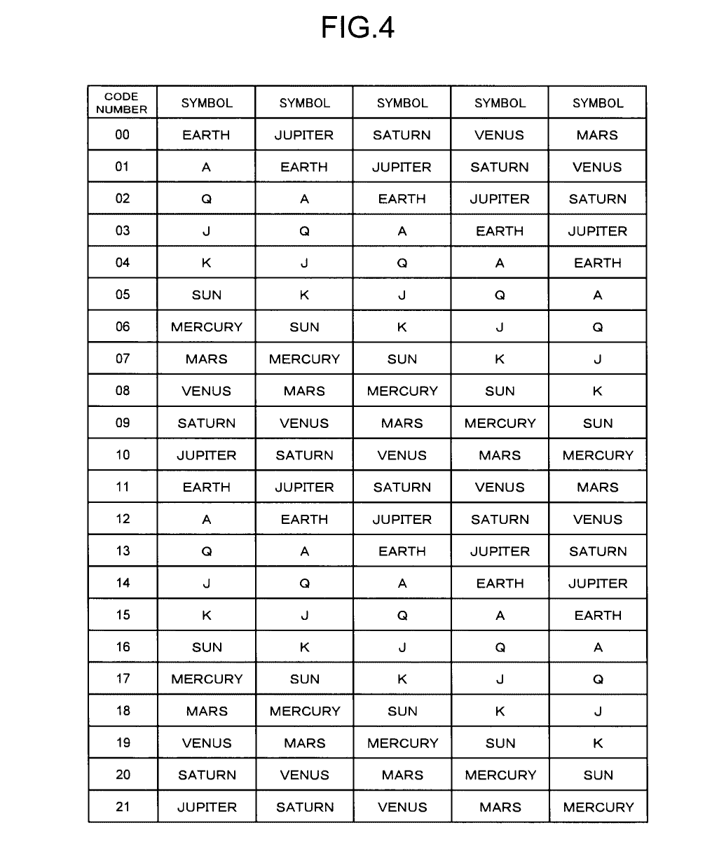

FIG. 4 is a view showing code numbers and symbols displayed in each of display block columns. As shown in FIG. 4, each column of a total of 22 symbols made up of code numbers is displayed in a scrolling manner in each of the display blocks 28. Each column of the symbols is constituted so that symbols “EARTH”, “JUPITER”, “SATURN”, “SUN”, “VENUS”, “MARS”, “MERCURY”, “K”, “J”, “Q”, and “A” are arranged in combination. These symbols are all scatter symbols.

Scatter symbols include one set for a special prize and one set for a scatter prize. In every game, the scatter symbols are automatically displayed (rearranged) in a scrolling and stopped manner in the respective display blocks 28 of the lower image display panel 16. A special prize (future game) is established when a predetermined number or more of trigger symbols set for the special prize are displayed in a stopped manner. Further, a predetermined number or more of trigger symbols set for the scatter prize are displayed in a stopped manner, a scatter prize (payout of a predetermined number of coins) is established in accordance with the type and number of displayed scatter symbols and the number of BETs. A scatter symbol is simply referred to a symbol as appropriate in the following description because all of the symbols are set to scatter symbols.

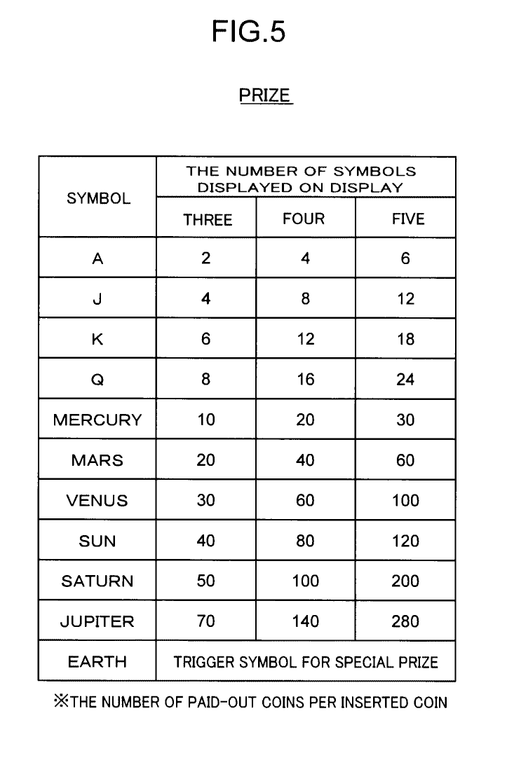

FIG. 5 is a view illustrating a scatter prize. Symbols “JUPITER”, “SATURN”, “SU”, “VENUS”, “MARS”, “MERCURY”, “K”, “J”, “Q”, and “A” are trigger symbols for the scatter prize. In a case where three or more of these symbols are displayed (rearranged) in a stopped manner in any of the display blocks 28 of the lower image display panel 16, a predetermined number of coins in accordance with the type and number of symbols and the number of BETs are paid out based upon a table in FIG. 5. As shown in FIG. 5, for example, when the number of symbols “JUPITER” displayed in a stopped manner in any of the display blocks 28 is three, seventy coins are paid out; the number is four, one hundred forty coins are paid out; and the number is five, two hundred eighty coins are paid out.

The symbol “EARTH” is a trigger symbol for a special prize. In a case where the three or more symbols “EARTH” are displayed in a stopped manner in any of the display blocks 28, a special prize is established and a process of a future game as the special prize is executed. In this future game process, a player executes a free game, the number of which was determined based upon the random number values obtained by executing a random number generation program included in symbol determination programs.

An outline of the game will be described hereinafter. BET information (such as the number of BETs) on a previous game is stored in the RAM 43 in advance. When the next game is started, the main CPU 41 accepts operation that a player made to the UTILITY button 200, and receives the auto-BET signal A1 (the first instruction signal) output from the auto-BET circuit 210 and the auto-SPIN signal A2 (the second instruction signal) output from the auto-SPIN circuit 220 in accordance with the input operation to the UTILITY button 200. The main CPU 41 automatically sets BETs equal to the number of BETs placed on a previous game, based upon the received auto-BET signal A1 and the BET information concerning the previous game stored in the RAM 43. The main CPU 41 then automatically executes a process of starting scroll-display of the plural types of symbols, based upon the received auto-SPIN signal A2. When a predetermined time has elapsed after start of the scroll-display, the main CPU 41 displays (rearranges) the plural types of symbols in a stopped manner in the respective display blocks 28, following stop of the scroll-display. The main CPU 41 then counts the number of symbols of the same type having been rearranged in the respective display blocks 28. As a result of counting, in a case where three or more symbols of the same type, which are set as a trigger for a scatter prize, are rearranged in any of the display blocks 28, the main CPU 41 pays out coins in accordance with the number and type of scatter symbols and the number of BETs. The main CPU 41 executes a future game as a special prize in a case where three or more symbols “EARTH”, which are set as a trigger for the special prize, are rearranged.

FIG. 6 is a block diagram depicting an internal configuration of the slot machine. A gaming board 50 is provided with: a CPU (Central Processing Unit) 51, a ROM55, and a boot ROM52, which were interconnected via an internal bus; a card slot 53S compatible with a memory card 53; and an IC socket 54S compatible with a GAL (Generic Array Logic) 54.

The memory card 53 is made up of non-volatile memories such as CompactFlash (registered trademark), and stores game programs. The game programs include a symbol determination program. The symbol determination program is intended for determining symbols (code numbers corresponding to symbols shown in FIG. 4) which are displayed in a stopped manner along the payline L.

In addition, a card slot 53S is constituted to enable removable insertion of the memory card 53, and the card slot is connected to a motherboard 40 by means of an IDE bus. Therefore, the memory card 53 is removed from the card slot 53S, other game programs are written into the memory card 53, and thereafter, the memory card 53 is inserted into the card slot 53S, thereby making it possible to vary the kinds or contents of the games performed at the gaming machine 10. The game programs include those which are relevant to the operating procedures for performing games. Furthermore, the game program includes image data or sound data to be output during the game.

The CPU51, the ROM55, and the boot ROM52 interconnected via the internal bus are connected to the motherboard 40 via a PCI bus. The PCI bus not only performs signal transmission between the motherboard 40 and the gaming board 50, but also supplies power from the motherboard 40 to the gaming board 50.

This motherboard 40 includes: a main CPU 41; a ROM (Read Only Memory) 42; a RAM (Random Access Memory) 43; and a communication interface (not shown). The main CPU 41 functions as the controller of the present invention.

The ROM 42 is made up of a memory device such as a flash memory, and stores a program such as a BIOS (Basic Input/Output System) executed by the main CPU 41 and permanent data. When the BIOS is executed by the main CPU 41, a process of initializing predetermined peripheral devices is executed and a process of capturing game programs stored in the memory card 53 through the gaming board 50 is started. In the present invention, the contents of the ROM 42 may be rewritable or not.

The RAM 43 stores data and programs used when the main CPU 41 is activated. The RAM 43 can also store game programs. The RAM 43 stores information concerning BETs placed on a previous game (such as the number of BETs and a predetermined symbol or a predetermined payline as a BET object), the number of symbols arranged in the respective display blocks 28, the amount of credit, the number of coins inserted in one game, the amount of payout, and the like.

Both a body PCB (Printed Circuit Board) 60 and a door PCB80, which will be described later, are connected to the motherboard 40 by the USB. Further, a power unit 45 is connected to the motherboard 40.

To the main body 60 and the door PCB 80, equipment or devices, for generating an input signal input to the main CPU 41, and those of which operation is controlled by means of a control signal output from the main CPU 41, are connected. The main CPU 41 executes the game programs stored in RAM 43, based upon an input signal that was input to the main CPU 41, thereby performing a predetermined computational process. Then, this CPU 41 stores results thereof into RAM43; and transmits control signals to equipment and devices as a control process relative to the equipment and devices.

Connected to the main body PCB 60 are a lamp 30, a hopper 66, a coin detection section 67, a graphic board 68, a speaker 29, a touch panel 69, a bill validator 22, a ticket printer 35, a card reader 36, a key switch 38S, and a data display 37. The lamp 30 lights in a predetermined pattern, based upon a control signal output from the main CPU 41.

The hopper 66 is installed in a cabinet 11, and a predetermined number of coins are paid out from the coin payout opening 19 to the coin tray 18, based upon the control signal output from the main CPU 41. A coin detection section 67 is provided inside of the coin payout opening 19, and outputs an input signal to the main CPU 41, if it is detected that a predetermined number of coins have been paid out from the coin payout opening 19.

The graphic board 68 performs control, based upon a control signal output from the main CPU 41, over the image display on the upper image display panel 33 and the lower image display panel 16 serving as an output device. Each of the display blocks 28 of the lower image display panel 16 displays symbols that are displayed in a scrolling manner or in a stopped manner, which is determined by selecting a random number value. The credit amount display portion 31 on the lower image display panel 16 displays the amount of credits stored in the RAM43. Further, a payout amount display portion 32 on the lower image display panel 16 displays the number of coins to be paid out. The graphic board 68 is provided with: a VDP (Video Display Processor), which generates image data, based upon the control signal output from the main CPU 41; and a video RAM, etc., which temporarily stores image data generated by the VDP. The image data used when the image data is generated by the VDP is read from the memory card 53, and thereafter, is included in the game programs stored in the RAM 43.

The bill validator 22 validates whether or not a bill is legitimate and accepts a legitimate bill into the cabinet 11. The bill validator 22, upon accepting a legitimate bill, outputs an input signal to the main CPU 41 based upon the bill amount. The main CPU 41 stores in the RAM 43 the amount of credits responsive to the amount of bills transmitted by the input signal.

The ticket printer 35, based upon a control signal output from the main CPU 41, prints on a ticket a bar code obtained by encoding data such as the number of credits, date and time, and the identification number of the slot machine 10 stored in the RAM43. The card reader 36 reads data from a smart card, thereby transmitting the read data to the main CPU 41 or writing data into the smart card, based upon the control signal from the main CPU 41. The key switch 38S is provided on the key pad 38, and outputs a predetermined input signal to the main CPU 41 when a player operates the key pad 38. The data display 37 displays, based upon a control signal output from the main CPU 41, the data read by the card reader 36 and the data input by a player through the key pad 38.

To the door PCB 80, a control panel 20, a reverter 21S, a coin counter 21C, and a cold cathode-ray tube 81 are connected. On a control panel 20, there are provided: the auto-BET switch 210S and the auto-SPIN switch 220S corresponding to the UTILITY button 200; a RESET switch 230S corresponding to the RESET button 230; a SPIN switch 23S corresponding to the SPIN button 23; a CHANGE switch 24S corresponding to the CHANGE button 24; a CASHOUT switch 25S corresponding to the CASHOUT button 25; a 1-BET switch 26S corresponding to the 1-BET button 26; and a MAX-BET switch 27S corresponding to the MAX-BET button 27. When a player operates the buttons 200, 230, and 23 to 27, the corresponding switches 210S, 220S, 230S, and 23S to 27S output input signals to the main CPU 41.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21S is operable based upon the control signal output from the main CPU 41. This reverter distributes the coins recognized to be legitimate by the coin counter 21C, into a cashbox (not shown) or a hopper 66 which was installed in the slot machine 10. In other words, if the hopper 66 is filled with coins, the legitimate coins are distributed to the cashbox by means of the reverter 21S. Otherwise, the legitimate coins are distributed to the hopper 66. The cold cathode-ray tube 81 functions as a backlight installed at the rear side of the lower image panel 16 and the upper image display panel 33, and lights based upon the control signal that was output from the main CPU 41.

A process executed in the slot machine 10 will be described next with reference to the drawings. The main CPU 41 progresses the game by reading out and executing a game program stored in the RAM 43.

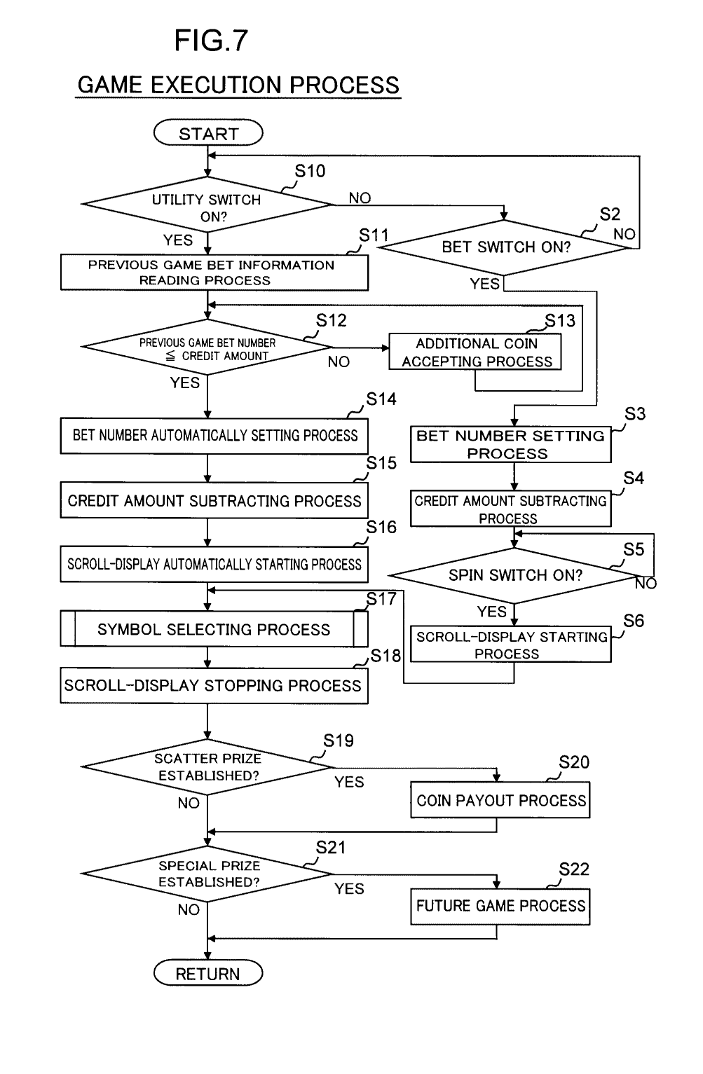

A game execution process will be described with reference to FIG. 7. FIG. 7 is a flowchart showing a subroutine of the game execution process, which is identical to that of in FIG. 1. The game executed by the game execution process is set so as to allow a player to select either one of two ways to execute the game, one way being carried out by operating the UTILITY button 200 whereas the other way being carried out by operating normal BET buttons 26, 27 and the SPIN button 23. The description is made on the presupposition that the RAM 43 previously stores the BET information including the number of BETs placed in a previous game.

First, the main CPU 41 judges at step S10, whether or not the UTILITY switch is in its ON state. The UTILITY switch being in its ON state indicates that the auto-BET circuit 210 and the auto-SPIN circuit 220 are controlled to its closed state with the contact piece 200A of the UTILITY button 200 reciprocated in accordance with the input operation. Specifically, the main CPU 41 judges whether or not it receives the auto-BET signal A1 (the first instruction signal) output from the auto-BET circuit 210 and the auto-SPIN signal A2 (the second instruction signal) output from the auto-SPIN circuit 220, upon the input operation performed by a player to the UTILITY button 200. The auto-BET circuit 210 and the auto-SPIN circuit 220 output the auto-BET signal A1 and the auto-SPIN signal A2, respectively, (see FIG. 2) under open/closed control with the use of the contact piece 200A functioning as a switch, of the UTILITY button 200, in accordance with the reciprocation of the UTILITY button 200. The auto-BET signal A1 is a signal intended to automatically set the number of BETs by referring to the BET information concerning the previous game stored in the RAM 43. The auto-SPIN signal A2 is to automatically rearrange the plural types of symbols in the respective display blocks 28. Where the main CPU 41 judges that the UTILITY switch is in its ON state (step S10: YES), the routine proceeds to step S11. Where the main CPU 41 judges that the UTILITY switch is not in its ON state (step S10: NO), the routine proceeds to step S2.

Next explained is a normal process executed in the slot machine in a case where the routine proceeds to step S2. At step S2, the main CPU 41 judges whether or not the BET switch is in its ON state. Specifically, the main CPU 41 judges whether or not it receives signals output from the BET switches 26S, 27S in accordance with operation performed by a player to the BET buttons 26, 27. In a case of receiving these signals, the main CPU 41 executes a process of setting the number of BETs in accordance with operation performed to the BET button. The routine proceeds to step S4 at which the main CPU 41 subtracts the number of coins corresponding to the set number of BETs from the credit amount stored in the RAM 43. The routine proceeds to step S5 at which the main CPU 41 judges whether or not the SPIN switch is in its ON state. Specifically, the main CPU 41 judges whether or not it receives a signal output from the SPIN switch 23S in accordance with operation performed by a player to the SPIN button 23. In a case of receiving the signal, the routine proceeds to step S6 at which the main CPU 41 executes a process of starting scroll-display of the plural types of symbols. Next, the routine proceeds to step S17 at which the main CPU 41 executes a process of selecting symbols by lottery, i.e., a symbol selecting process, to be described later.

A process executed in a case where the routine proceeds to step S11 will be described. At step S11, the main CPU 41 executes a process of reading BET information concerning the previous game. Specifically, the main CPU 41 reads out the number of BETs included in the BET information concerning the previous game stored in the RAM 43. The BET information includes the number of BETs placed in the previous game and a symbol or a payline on which BETs are placed.

Next, the main CPU 41 judges at step S12, whether or not the electrically stored amount of credit is greater than or equal to the number of BETs placed in the previous game read out of the RAM 43 at step S11. In a case where the main CPU 41 judges that the credit amount is greater than or equal to the number of BETs placed in the previous game (S12: YES), the routine proceeds to step S14. In a case where the main CPU 41 judges that the credit amount is smaller than the number of BETs placed in the previous game (S12: NO), the routine proceeds to step S13.

Next, at step S13, the main CPU 41 executes a process of accepting additionally inserted coins. Specifically, the main CPU 41 displays on the lower image display panel 16 or the upper image display panel 33, information for prompting a player to insert coins. Accordingly, where coins are inserted by the player, the number of inserted coins is added to the credit amount. When the number of coins is added to the credit amount, the main CPU 41 stores the credit amount in the RAM 43 while repeating the process at step S12.

Next, at step S14, the main CPU 41 executes a process of automatically setting the number of BETs. Specifically, the main CPU 41 automatically sets the number of BETs equal to the BETs placed in the previous game, based upon the auto-BET signal A1 output from the auto-BET circuit 210 and the BET information concerning the previous game read out of the RAM 43 at step S11. The main CPU 41 then stores in the RAM 43, the BET information including the number of BETs set for this game.

Next, at step S15, the main CPU 41 executes a process of subtracting from the credit amount. Specifically, the main CPU 41 reads out the BET information stored in the RAM 43 at step S14 and the electrically stored amount of credit, thereby subtracting the number of coins corresponding to the number of BETs set at step S14, from the amount of credit. The main CPU 41 then stores again the credit after subtraction in the RAM 43.

Next, at step S16, the main CPU 41 executes a process of automatically starting scroll-display. Specifically, the main CPU 41 automatically starts scroll-display of the plural types of symbols, based upon the auto-SPIN signal A2 output at step S11 from the auto-SPIN circuit 220.

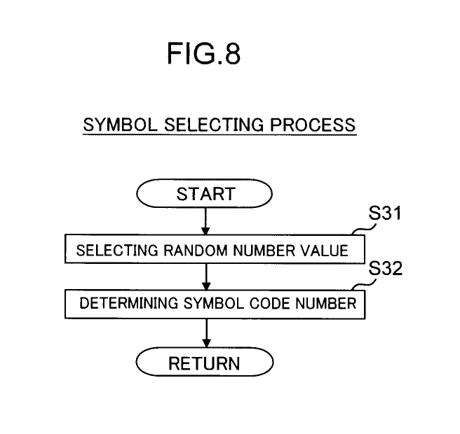

At step S17, the main CPU 41 then executes a symbol selecting process after completion of the process at step S6 or step S16. Specifically, the main CPU 41 executes a symbol selecting program stored in the RAM 43, thereby determining a code number at the time of stop of scrolling of the symbols. This process will be described later with reference to FIG. 8. This embodiment describes a case where one or more prizes are determined from among plural types of prizes by selecting by lottery the symbols to be displayed in a stopped manner. However, the present invention is not limitative thereto, and, for example, may be applicable to a case in which one or more prizes are selected and determined from among the plural types of prizes, and then, the combinations of symbols displayed in its stopped manner are determined by lottery based upon the above-mentioned prizes.

Next, at step S18, the main CPU 41 executes a process of stopping scroll-display. Specifically, when a predetermined time has elapsed after start of scroll-display of the plural types of symbols, the main CPU controls display such that the symbols determined at step S17 are displayed in a stopped manner in the respective display blocks 28 along with the stop of the scroll-display.

Next, at step S19, the main CPU 41 judges whether or not a scatter prize is established. Specifically, the main CPU 41 judges whether or not the scatter prize is established by determining whether or not three or more symbols for the scatter prize are displayed in a stopped manner in any of display blocks 28. More specifically, this CPU judges whether or not three or more symbols of the same type are displayed based upon FIG. 5, in a stopped manner from among “JUPITER”, “SATURN”, “SUN”, “VENUS”, “MARS”, “MERCURY”, “K”, “J”, “Q”, and “A”. In a case of judging that the scatter prize is established (S19: YES), the routine proceeds to step S20 at which the main CPU 41 performs a coin payout process. Where the judgment result is negative (S19: NO), the routine proceeds to step S20 without performing the coin payout process.

Next, at step S20, the main CPU 41 executes the coin payout process. Specifically, upon judging at step S19 that three or more symbols of the same type as a trigger symbol for scatter prize are displayed in a stopped manner in the display blocks 28, based on FIG. 5, the main CPU 41 executes the coin payout process in accordance with the number and type of symbols displayed in a stopped manner and the number of BETs. After the main CPU 41 completes the payout process, the routine proceeds to step S21.

Next, at step S21, the main CPU 41 judges whether or not a special prize is established. In this case, the main CPU 41 judges whether or not three or more symbols “EARTH” as a trigger for a special prize are displayed in a stopped manner. In a case where the main CPU 41 judges that the special prize is established (S21: YES), the routine proceeds to step S22. In a case where the main CPU 41 judges the special prize is not established (S21: NO), this subroutine is completed.

Next, at step S22, the main CPU41 executes a future game process. Specifically, upon judging at step S21 that the special prize is established, the main CPU 41 reads out of the RAM 43, a program for executing the future game process. The main CPU 41 then executes a random number generation program included in the symbol selecting program, thereby selecting a random number value. Further, this CPU 41 executes free games by a predetermined number of times based upon the selected random number value. After executing the future game process, the main CPU 41 executes coin payout, based upon the payout number of coins acquired in the future game process. After that, the main CPU 41 terminates this subroutine. In the future game process, the free game is carried out without inputting the number of BETs.

In a case where the main CPU 41 judges at step S19 that no scatter prize is established (S19: NO) and judges at step S21 that no special prize is established (S21: NO), it is determined to be “losing”, which does not come under any of the prizes. The word “losing” used herein denotes a case in which no coin payout is performed.

Next, a process of selecting symbols will be described with reference to FIG. 8. FIG. 8 is a flowchart showing a subroutine of the symbol selecting process executed at step S17, shown in FIG. 7. The main CPU 41 carries out this process by executing a symbol selecting program stored in the RAM 43.

First, at step S31, the main CPU 41 executes a process of selecting a random number value. Specifically, the main CPU 41 selects five random number values corresponding to five symbol columns, respectively, from a numeric range between 0 and 255, by executing a random number generation program included in the symbol selecting program. The present embodiment describes a case of generating random numbers in a programmable fashion (a case of using so called software random numbers). In the present invention, however, a random number generator is provided, whereby random numbers may be sampled from the random number generator (so called hardware random numbers may be used).

Next, at step S32, the main CPU 41 determines code numbers of symbol columns (see FIG. 4), based upon the five random number values selected at step S31. Code numbers of symbol columns correspond to code numbers of symbols displayed on the payline L in a stopped manner. The main CPU 41 determines a prize by determining code numbers for symbol columns, respectively. As shown in FIG. 7, for example, in a case where code numbers of symbols have been determined to be “00”, “01”, “02”, “03”, and “04”, the corresponding prize is determined to be “EARTH”.

As described above, by the slot machine 10 and the playing method thereof according to this embodiment, the RAM 43 previously stores the BET information including the number of BETs placed in the previous game. In the next game, the main CPU 41 accepts input operation from the UTILITY button 200. The main CPU 41 then the auto-BET signal A1 and the auto-SPIN signal A2 output from the auto-BET circuit 210 and the auto-SPIN circuit 220, respectively, in accordance with the input operation made to the UTILITY button 200. Based upon the accepted auto-BET signal A1 and auto-SPIN signal A2 and the BET information concerning the previous game, stored in the RAM 43, the main CPU 41 automatically sets the number of BETs equal to that of BETs placed in the previous game while automatically rearranging the plural types of symbols in the display blocks 28, respectively. The UTILITY button 200 is configured to reciprocate in accordance with the input operation by the player. The auto-BET circuit 210 and the auto-SPIN circuit 220 are under open/closed control in accordance with the reciprocation of the UTILITY button 200 and in this manner, output the auto-BET signal A1 and the auto-SPIN signal A2, respectively.

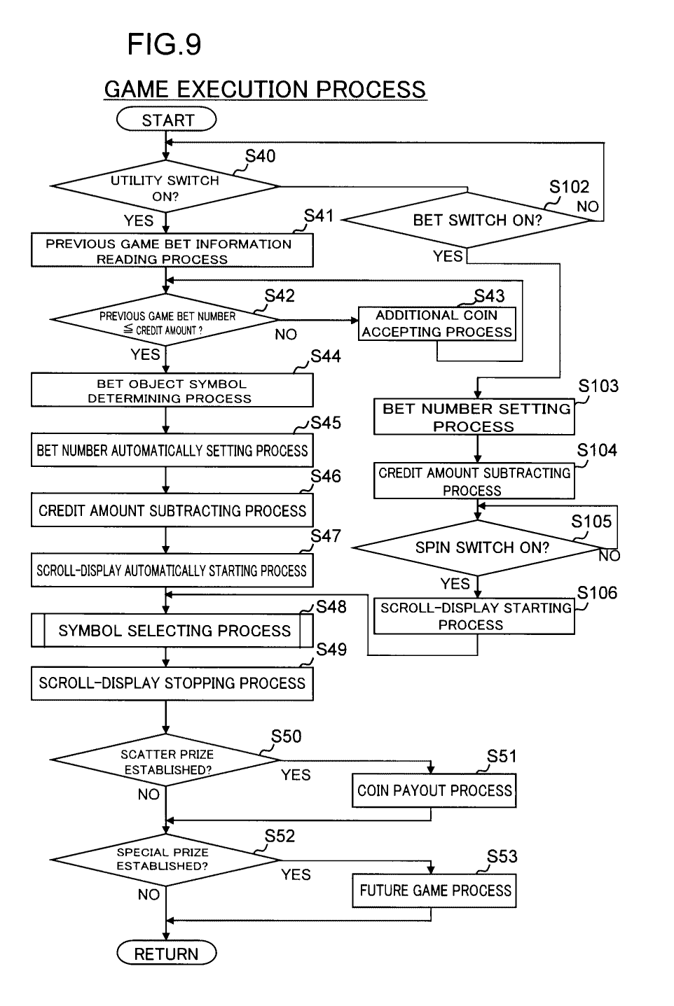

Next, a game execution process according to another embodiment will be described with reference to FIG. 9. FIG. 9 is a flowchart showing a subroutine of the game execution process according to the aforementioned another embodiment. In description concerning the game execution process shown in FIG. 9, overlaps with the game execution process shown in FIG. 7 is arbitrarily omitted.

The game executed by the game execution process shown in FIG. 9 is to award a prize in a case where three or more predetermined symbols on which the player placed BETs are displayed in a stopped manner, based on FIG. 5. At this time, the RAM 43 stores the predetermined symbol on which the player placed BETs and the number of BETs in the previous game, as the BET information concerning the previous game. In the next game, the main CPU 41 determines the same symbol as the predetermined one on which the player placed BETs in the previous game, by referring to the BET information concerning the previous game, stored in the RAM 43. The main CPU 41 then automatically sets to place the number of BETs placed on the predetermined symbol in the previous game, on the predetermined symbol determined above while automatically rearranging the plural types of symbols in the display blocks 28. The main CPU 41 awards a prize in a case where three or more symbols of the same type set to the BET object are displayed in a stopped manner. Hereinafter, a situation shown in FIG. 9 will be described on the presupposition that the RAM 43 previously stores the BET information (the predetermined symbol on which the player placed BETs and the number of BETs) concerning the previous game.

At step S40, the main CPU 41 judges whether or not the UTILITY button is in its ON state. Specifically, the main CPU 41 judges whether or not it receives the auto-BET signal A1 and the auto-SPIN signal A2 output in accordance with the input operation made to the UTILITY button 200. In a case where the main CPU 41 judges that the UTILITY button is in its ON state (S40: YES), the routine proceeds to step S41. In a case where the main CPU 41 judges that the UTILITY button is not in its ON state (S40: NO), the routine proceeds to step S102 at which the main CPU 41 judges whether or nor the BET switch is in its ON state. At step S102, in a case where the BET switch is in its ON state, processes at steps S103, S104, S105, and S106 similar to those at steps S3, S4, S5, and S6 of FIG. 7 described above are executed.

Next, at step S41, the main CPU 41 executes a process of reading out the BET information concerning the previous game. Specifically, the main CPU 41 reads out the predetermined symbol on which the player placed BETs and the number of BETs stored in the RAM 43. The routine proceeds to step S42 at which the main CPU 41 reads the current credit amount out of the RAM 43 to judge whether or not the current credit amount is greater than or equal to the number of BETs placed in the previous game. In a case where the main CPU 41 judges that the current credit amount is greater than or equal to this number (S42: YES), the routine proceeds to step S44.

Next, at step S44, the main CPU 41 executes a process of determining a symbol as a BET object. Specifically, based upon the predetermined symbol on which the player placed BETs in the previous game, read out of the RAM 43 at step S41, the main CPU 41 determines as a BET object, the same symbol as the predetermined one on which the player placed BETs in the previous game.

Next, at step S45, the main CPU 41 executes a process of automatically setting the number of BETs. Specifically, based upon the auto-BET signal A1 received at step S40 and the number of BETs placed in the previous game read out of the RAM 43 at the step S41, the main CPU 41 automatically sets to place the number of BETs equal to that of BETs that the player placed in the previous game, on the predetermined symbol as the BET object determined at step S44.

Next, at step S47, the main CPU 41 executes a process of starting scroll-display. Specifically, the main CPU 41 automatically starts scroll-display of the plural types of symbols based upon the auto-SPIN signal A2 received at step S40.

Next, the routine proceeds to steps S48 and S49 at which the main CPU 41 executes the symbol selecting process and the symbol scroll-display stopping process. The routine proceeds to steps S50 and S52 at which the main CPU 41 then judges whether or not three or more symbols on which the player placed BETs from among the plural symbols displayed in a stopped manner on the respective blocks 28. In a case where a symbol on which the player placed BETs is the scatter symbol and the main CPU 41 judges that the three or more scatter symbols are displayed in a stopped manner, the routine proceeds to step S51 at which the main CPU 41 executes the coin payout process. In a case where a symbol on which the player placed BETs is the symbol “EARTH” as a trigger for the special prize and the main CPU 41 judges that the three or more symbols “EARTH” are displayed in a stopped manner, the routine proceeds to step S53 at which the main CPU 41 executes the future game execution.

In the above case, the main CPU 41 determines as the BET object, the symbol of the same type as that of the predetermined symbol on which the player placed BETs in the previous game included in the BET information, by referring to the BET information concerning the previous game, read out of the RAM 43, in the process of determining a symbol as the BET object at step S44. However, the present invention is not limitative thereto. For example, the main CPU 41 may determine at random a symbol of a different type from that of the predetermined symbol on which the player placed BETs in the previous game. In this case, at the next step, the main CPU 41 automatically sets to place the number of symbols equal to that of BETs placed in the previous game, on the determined different symbol.

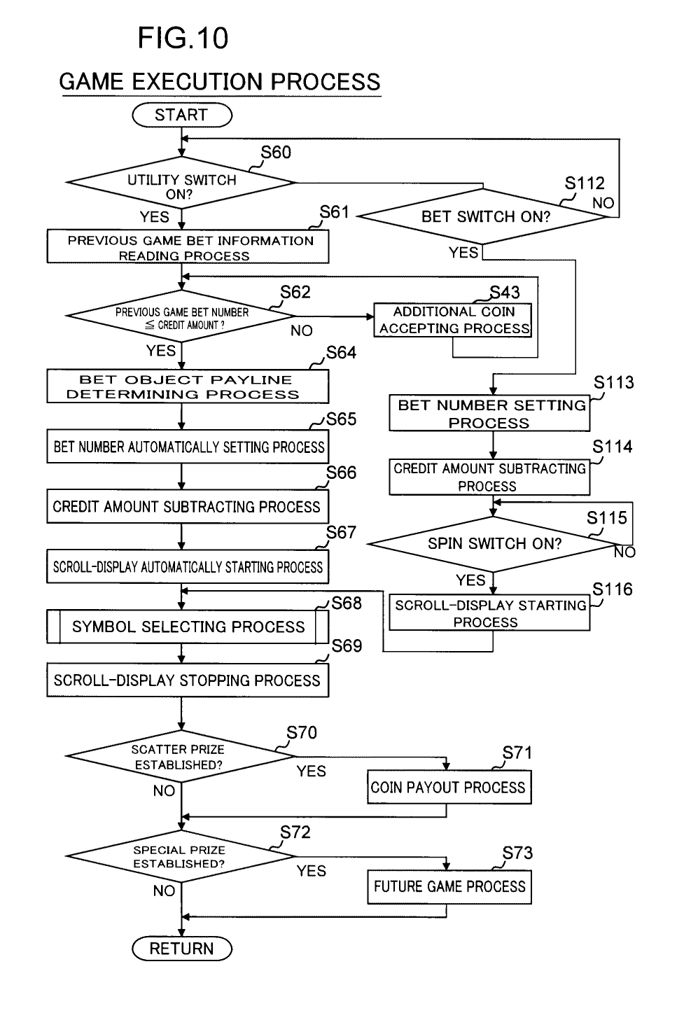

Next, the game execution process according to yet another embodiment will be described by referring to FIG. 10. FIG. 10 is a flowchart showing a subroutine of the game execution process according to the another embodiment. In description concerning the game execution process shown in FIG. 10, overlaps with the game execution process at FIGS. 7 and 9 is arbitrarily omitted.

The game executed by the game execution process shown in FIG. 10 is to award a prize in a case where three or more symbols of the same type are displayed in a stopped manner on a payline on which the player placed BETs. At this time, the RAM 43 stores as the BET information concerning the previous game, a payline on which the player placed BETs and the number of BETs placed on the payline. In the next game, the main CPU 41 determines the same payline as the predetermined one on which the player placed BETs in the previous game, by referring to the BET information concerning the previous game stored in the RAM 43. The main CPU 41 automatically sets to place the number of BETs which the player placed on the predetermined payline in the previous game, on the determined payline while automatically rearranging the plural types of symbols in the respective display blocks 28. The main CPU 41 awards a prize in a case where three or more symbols of the same type are displayed in a stopped manner on the predetermined payline on which the player placed BETs. Hereinafter, a situation shown in FIG. 10 will be described on the presupposition that the RAM 43 previously stores the BET information (the predetermined payline on which the player placed BETs and the number of BETs) concerning the previous game.

At step S60, the main CPU 41 judges whether or not the utility switch is in its ON state. Specifically, the main CPU 41 judges whether or not it receives the auto-SPIN signal A1 and the auto-SPIN signal A2 output in accordance with input operation made to the utility button 200. In a case where the main CPU 41 judges that the input operation has been made (S60: YES), the routine proceeds to step S61. In a case where the main CPU 41 judges that the utility switch is not in its ON state (S60: NO), the routine proceeds to step S112 at which the main CPU 41 judges whether or not the BET switch is in its ON state. At step S112, in a case where the BET switch is in its ON state, the main CPU 41 executes the steps S113, S114, S115, and S116 that are the same processes as those at steps S3, S4, S5, and S6.

Next, at step S61, the main CPU 41 executes a process of reading out the BET information concerning the previous game. Specifically, the main CPU 41 reads the predetermined payline on which the player placed BETs and the number of BETs stored in the RAM 43. The routine proceeds to the step S62 at which the main CPU 41 reads the current credit amount out of the RAM 43 to judge whether or not the current credit amount is greater than or equal to the number of BETs placed in the previous game read out at step S61. In a case where the main CPU 41 judges that the current credit amount is greater than or equal to the number of BETs (S62: YES), the routine proceeds to step S64.

Next, at step S64, the main CPU 41 executes a process of determining a payline on which BETs are to be placed, i.e., a payline as a BET object. Specifically, the main CPU 41 determines a payline of the same type as that of the predetermined payline on which the player placed BETs in the previous game, based upon the predetermined payline on which the player placed BETs in the previous game, read out of the RAM 43 at step S61.

Next, at step S65, the main CPU 41 executes a process of automatically setting the number of BETs. Specifically, the main CPU 41 automatically sets the number of BETs equal to that of BETs placed in the previous game, on the predetermined payline as the BET object determined at step S64, based upon the auto-BET signal A1 received at step S60 and the number of BETs which the player placed in the previous game, read out of the RAM 43 at step S61.

Next, at step S67, the main CPU 41 executes a process of automatically starting scroll-display. Specifically, the main CPU 41 automatically starts scroll-display of the plural types of symbols, based upon the auto-SPIN signal A2 received at step S60.

Next, the routine proceeds to steps S68 and S69 at which the main CPU 41 executes the symbol selecting process and a scroll-display stopping process. The routine then proceeds to steps S70 and S72 at which the main CPU 41 judges whether or not the plural types of symbols displayed in a stopped manner on the respective display blocks 28 include three or more symbols of the same type. In a case where the main CPU 41 judges that three or more scatter symbols of the same type are displayed in a stopped manner on the predetermined payline on which the player placed BETs, the routine proceeds to step S71 at which the main CPU 41 executes the coin payout process. In a case where the main CPU 41 judges that three or more symbols “EARTH” as a trigger for a special prize are displayed in a stopped manner on the predetermined payline on which the player placed BETs, the routine proceeds to step S73 at which the main CPU 41 executes a future game process.

In the above case, the main CPU 41 determines as the BET object, the payline of the same type as that of the predetermined one on which the player placed BETs in the previous game, information on which is included in the BET information, by referring to the BET information concerning the previous game, read out of the RAM 43 in the process of determining the payline as the BET object at step S64. However, the present invention is not limited thereto. For example, the main CPU may determine at random a payline of a different type from that of the predetermined payline on which the player placed BETs in the previous game. In this case, at the next step, the main CPU 41 automatically sets to place the number of BETs equal to that of BETs which the player placed in the previous game, on the determined different payline.

The above case described that the player performs input operation to the utility button 200 in each game. However, the present invention is not limitative thereto. For example, the utility button 200 may be automatically operated when the previous game is over. Further, automatic operation of the utility button 200 may be controlled only during a predetermined period of a game such as a special game. In a case where the automatic operation is made to the utility button 200, the automatic operation of the utility button 200 may be controlled until receipt of the input operation from the RESET operation 230.

The above case described that the main CPU 41 automatically sets, in a next game, a symbol or payline of a different type from that of the predetermined symbol or payline on which a player placed BETs in a previous game (steps S44 and S64). However, this invention is not limitative thereto. The main CPU 41 may determine the above-described process in a case where a predetermined condition is met. The predetermined condition is met when one of two conditions is met, in which one condition relates to the number of successive games executed upon operation to the utility button 200 and the other condition relates to a symbol changing mode set by a player.

The above case described that a combination of the plural symbols that forms a prize is based upon the number of symbols of the same type. However, the present invention is not limitative thereto. The plural types of symbols may form a combination.

While the above case described that a total of 15 symbols in 5 columns and 3 rows are displayed, the display format of symbols in the present invention is not limitative to that of 5 columns and 3 rows, and is applicable to a variety of display formats such as that of 3 columns and 3 rows. Further, while the above case described that symbols were displayed in a scrolling manner in each of the display block columns, each of these symbols may be individually displayed in a scrolling manner.

While the above case described that the symbols were displayed in a scrolling manner with the use of a liquid crystal display device or the like, the present invention is not limitative thereto. In a case where mechanical reels are employed, the symbols may be expressed and displayed on the surfaces thereof.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

The more important features of the invention have thus been outlined, rather broadly, in order that the aforementioned detailed description thereof may be better understood, and in order that the present contribution to the art may be better appreciated. There are, of course, additional features of the invention that were described above and which formed the subject matter of the claims appended hereto. In this respect, upon explaining at least one embodiment of the invention in detail, it is to be understood that the invention is not limitative in its application to the details of construction and to the arrangements of the components set forth in the aforementioned description or illustrated in the drawings. According to the invention, other embodiments can be variously practiced and carried out as well. Also, it is to be understood that the phraseology and terminology employed herein are merely intended for the descriptive purpose and should not be regarded as limiting. As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These matters together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matters in which there are illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art. A procedure is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities. Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices. The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general-purpose machines may be used with programs written in accordance with the teachings herein, or it may prove more convenient to construct more specialized apparatus to perform the required method steps. The required structure for a variety of these machines will appear from the description given.

What is claimed is:

1. A slot machine, comprising:
(i) a display device having thereon plural types of symbols arranged;
(ii) a memory for storing BET information including the number of BETs placed in a previous game;
(iii) an input device which includes a predetermined electric circuit for outputting a first instruction signal intended to automatically set the number of BETs by referring to the BET information concerning the previous game, stored in the memory, and a second instruction signal intended to automatically rearrange the plural types of symbols on the display device; accepts input operation; and exercises opening and closing control over the predetermined electric circuit so as to output the first instruction signal and the second instruction signal in accordance with the accepted input operation; and
(iv) a controller, the controller being programmed to:
(a) store in the memory, the BET information including the number of BETs placed in the previous game;
(b) accept the input operation made to the input device in a next game;
(c) accept the first instruction signal and the second instruction signal output from the predetermined electric circuit in accordance with the input operation made to the input device;
(d) automatically set the number of BETs equal to that of BETs placed in the previous game, based upon the first instruction signal accepted in the itemized (c) and the BET information concerning the previous game, stored in the memory in the itemized (a);
(e) automatically rearrange the plural types of symbols on the display device based upon the second instruction signal accepted in the itemized (c); and
(f) award a prize with a predetermined value in a case where the plurality of symbols rearranged on the display device form a predetermined combination.

2. The slot machine according to claim 1, wherein:
the input device is configured so as to reciprocate in accordance with the input operation; and
the predetermined electric circuit is configured so as to output the first instruction signal and the second instruction signal under the opening and closing control in accordance with reciprocation of the input device.

3. The slot machine according to claim 1, wherein:
the memory stores an electric gaming value; and
the controller, in the next game, executes:
the itemized (d) and (e) in a case where the electronic gaming value stored in the memory is greater than or equal to the number of BETs placed in the previous game, stored in the memory; and
the itemized (d) and (e) after acceptance of a gaming value added by a player, in a case where the electronic gaming value stored in the memory is smaller than the number of BETs placed in the previous game, stored in the memory.

4. The slot machine according to claim 1, wherein:
the BET information stored in the memory includes the number of BETs placed on a predetermined symbol selected in the previous game; and
the controller:
stores in the memory, in the itemized (a), the BET information including the number of BETs placed on the predetermined symbol selected in the previous game;
automatically sets, in the itemized (d), the number of BETs placed on the predetermined symbol selected in the previous game, based upon the first instruction signal accepted in the itemized (c) and the BET information concerning the previous game, stored in the memory in the itemized (a); and
awards a prize with a predetermined value, in the itemized (f), in a case where the plurality of symbols including the predetermined symbol, rearranged on the display device, form a predetermined combination.

5. The slot machine according to claim 1, wherein:
the BET information stored in the memory includes the number of BETs placed on at least one payline set in the previous game; and
the controller:
stores in the memory, in the itemized (a), the BET information including the number of BETs placed on the at least one payline set in the previous game;
automatically sets, in the itemized (d), the number of BETs placed on the at least one payline set in the previous game, based upon the first instruction signal accepted in the itemized (c) and the BET information concerning the previous game stored in the memory, in the itemized (a); and
awards a prize with a predetermined value, in the itemized (f), in a case where the plurality of symbols rearranged on the display device form a predetermined combination on the at least one set payline.

6. The slot machine according to claim 1, wherein:
the input device is automatically subjected to the input operation upon completion of the previous game.

7. The slot machine according to claim 1, wherein:
the input device is automatically subjected to the input operation during a predetermined period of a game.

8. The slot machine according to claim 1, further comprising:
a reset input device for accepting a predetermined input operation, wherein:
the input device is automatically subjected to the input operation during a period from acceptance of the input operation made to the input device to the predetermined input operation made to the reset input device.

9. A slot machine, comprising:
(i) a display device having thereon plural types of symbols arranged;
(ii) a memory for storing BET information including the number of BETs placed on a predetermined symbol selected in a previous game;
(iii) an input device which includes a predetermined electric circuit for outputting a first instruction signal intended to automatically set the number of BETs by referring to the BET information concerning the previous game, stored in the memory, and a second instruction signal intended to automatically rearrange the plural types of symbols on the display device; accepts input operation; and exercises opening and closing control over the predetermined electric circuit so as to output the first instruction signal and the second instruction signal in accordance with the accepted input operation; and
(iv) a controller, the controller being programmed to:
(a) store in the memory, the BET information including the number of BETs placed on the predetermined symbol selected in the previous game;
(b) accept the input operation made to the input device in a next game;
(c) accept the first instruction signal and the second instruction signal output from the predetermined electric circuit in accordance with the input operation made to the input device;
(d) determine a symbol different from the predetermined symbol selected in the previous game and automatically set to place on the determined different symbol, the number of BETs equal to that of BETs placed in the previous game, based upon the first instruction signal accepted in the itemized (c) and the BET information concerning the previous game, stored in the memory in the itemized (a);
(e) automatically rearrange the plural types of symbols on the display device based upon the second instruction signal accepted in the itemized (c); and
(f) award a prize with a predetermined value in a case where the plurality of symbols including the different symbol, rearranged on the display device form a predetermined combination.

10. A slot machine, comprising:
(i) a display device having thereon plural types of symbols arranged;
(ii) a memory for storing BET information including the number of BETs placed on at least one payline set in a previous game;
(iii) an input device which includes a predetermined electric circuit for outputting a first instruction signal intended to automatically set the number of BETs by referring to the BET information concerning the previous game, stored in the memory, and a second instruction signal intended to automatically rearrange the plural types of symbols on the display device; accepts input operation; and exercises opening and closing control over the predetermined electric circuit so as to output the first instruction signal and the second instruction signal in accordance with the accepted input operation; and
(iv) a controller, the controller being programmed to:
(a) store in the memory, the BET information including the number of BETs placed on the at least one payline set in the previous game;
(b) accept the input operation made to the input device in a next game;
(c) accept the first instruction signal and the second instruction signal output from the predetermined electric circuit in accordance with the input operation made to the input device;
(d) determine a payline different from the predetermined payline set in the previous game and automatically set to place on the determined different payline, the number of BETs equal to that of BETs placed in the previous game, based upon the first instruction signal accepted in the itemized (c) and the BET information concerning the previous game, stored in the memory in the itemized (a);
(e) automatically rearrange the plural types of symbols on the display device based upon the second instruction signal accepted in the itemized (c); and
(f) award a prize with a predetermined value in a case where the plurality of symbols rearranged on the display device form a predetermined combination on the at least one set payline.

11. A method of playing a slot machine, comprising the steps of:
(i) storing in a memory, BET information including the number of BETs in a previous game;
(ii) accepting a first instruction signal and a second instruction signal output in accordance with reciprocation of an input device, the first instruction signal being intended to automatically set the number of BETs by referring to the BET information concerning the previous game, stored in the memory, the second instruction signal being intended to automatically rearrange plural types of symbols on a display device;
(iii) automatically setting the number of BETs equal to that of BETs in the previous game, based upon the first instruction signal accepted in the itemized (ii) and the BET information concerning the previous game, stored in the memory in the itemized (i); and
(iv) automatically rearranging the plural types of symbols on the display device, based upon the second instruction signal accepted in the itemized (ii).
